(19) United States
(12) Patent Application Publication
(10) Pub. No.: US 2001/0050946 A1
(43) Pub. Date: Dec. 13, 2001

(54) Code division multiple access transmitter and receiver

(76) Inventor: Nabil Khalifa, Le Mans (FR)

Correspondence Address: Corporate Patent Counsel, U.S. Philips Corporation, 580 White Plains Road, Tarrytown, NY, 10591, US

(21) Appl. No.: 09/908,603

(22) Filed: Jul. 19, 2001

Related U.S. Application Data
(63) Continuation of application No. 09/299,527, filed on Apr. 26, 1999.

(30) Foreign Application Priority Data
Apr. 30, 1998 (EP) 98401054.6

(51) Int. Cl. H04K 1/00

(52) U.S. Cl. 375/140; 370/335

(57) ABSTRACT

The input data to a CDMA transmitter is used to introduce a slight frequency offset to the clock that is used to generate the CDMA code. At the receiver, the frequency-offset CDMA signal proportionately affects the magnitude of output signals from one or more CDMA correlators. A composite signal that is based on the magnitudes of the output signals is compared to a set of predefined threshold levels to provide the demodulated output data.

### CROSS-REFERENCE TO RELATED APPLICATIONS

This is a continuation-in-part application of U.S. patent application Ser. No. 09/299,527, filed Apr. 26, 1999.

### BACKGROUND OF THE INVENTION

1. Field of the Invention

The present invention relates to a code division multiple access transmitter comprising a modulation stage followed by an up-converter, and to a code division multiple access receiver comprising reciprocally a down converter followed by a demodulation stage. This invention may have important applications in relation with the future mobile communications standards which will use code-division multiple access modulation techniques for all types of channel.

2. Description of the Related Art

Spread spectrum transmission techniques, implemented for over thirty years in the field of military communications, may also be of interest for use in mobile radio applications. According to the basic principle of these techniques, a signal is spread over a frequency bandwidth that is much wider than the minimum bandwidth required to transmit the signal. More precisely, the idea behind spread spectrum is to transform a signal with a given bandwidth into a noise-like signal of much larger bandwidth. Hence, the total power transmitted when a spread spectrum technique is used (this power is assumed to be the same as that in the original signal) is spread over 10 to 1000 times the original bandwidth, while its power spectral density is correspondingly reduced by the same amount. This feature gives to a spread spectrum signal the characteristic of causing little interference to a narrow-band user.

This frequency-spreading characteristic offers a transmitted signal the possibility of using CDMA (code-division multiple access), particularly in order to support simultaneous digital communication among a large community of relatively uncoordinated users. The CDMA multiplexing technique is described, for instance, in the document “Overview of Multicarrier CDMA”, by S. Hara and R. Prasad, IEEE Communications Magazine, Dec. 1997, pp.126-133. In fact, a CDMA system is a spread spectrum system in which, in order to share the same bandwidth, the users are assigned different spreading codes (generated by a pseudo-noise generator and determined by code parameters, such as a chip length T and a code length N) in order to spread their signals over a bandwidth much wider than their transmitted data bandwidth, a specific signature sequence being assigned to each user to ensure signal separability.

### SUMMARY OF THE INVENTION

An object of the invention is to provide a CDMA transmitter based on a new principle of modulation.

To this end, the invention relates to a CDMA transmitter as defined in the opening paragraph, characterized in that said modulation stage comprises, in series, at least a data-to-frequency offset converter, a frequency synthesizer controlled by said converter, and a code generator, wherein the data-to-frequency offset converter is configured to accept as input a data-item that is one of a plurality of states, and to provide as an output, a select offset of a plurality of predefined offsets, based on the input data-item, and the frequency synthesizer is configured to generate a clock for the code generator with a frequency offset that corresponds to the select offset of the plurality of predefined offsets.

In a particular embodiment of said transmitter, the code generator is periodically initialized by an initialization module by means of which at least one code period without any frequency offset is provided each P code periods.

Another object of the invention is to provide a corresponding CDMA receiver for demodulating signals generated by such a CDMA transmitter.

To this end, the invention relates to a CDMA receiver as defined in the opening paragraph, characterized in that said demodulation stage receives a signal that has been modulated by a modulation stage, comprising at least a data-to-frequency offset converter, a frequency synthesizer controlled by said converter and a code generator, and comprises a demodulation branch and a calibration branch, said demodulation branch comprising correlation means for detecting said frequency offsets, and decision means for providing the corresponding demodulated data, and said calibration branch being provided for a periodical frequency control of the reference code generator of said receiver before data demodulation.

In the case the code generator of the transmitter has been periodically initialized so that at least one code period without any frequency offset is provided each P code periods, any offset detected at the receiving side can then be considered as a wrong one that does not correspond to input data.

### BRIEF DESCRIPTION OF THE DRAWINGS

The particular aspects of the invention will now be explained with reference to the embodiment described hereinafter and considered in connection with the accompanying drawings, in which

FIG. 1 shows a simplified architecture for a conventional direct sequence spread spectrum transmitter;

FIG. 2, illustrating the principle of the invention, shows an original code OC and, on the upper and lower lines, two examples of frequency offset affected codes;

FIG. 3 shows an embodiment of a CDMA transmitter according to the invention;

FIG. 4 illustrates the principle of demodulation in a CDMA receiver according to the invention; and

FIG. 5 shows an example of frequency offset and multi-code mapping.

### DESCRIPTION OF THE PREFERRED EMBODIMENTS

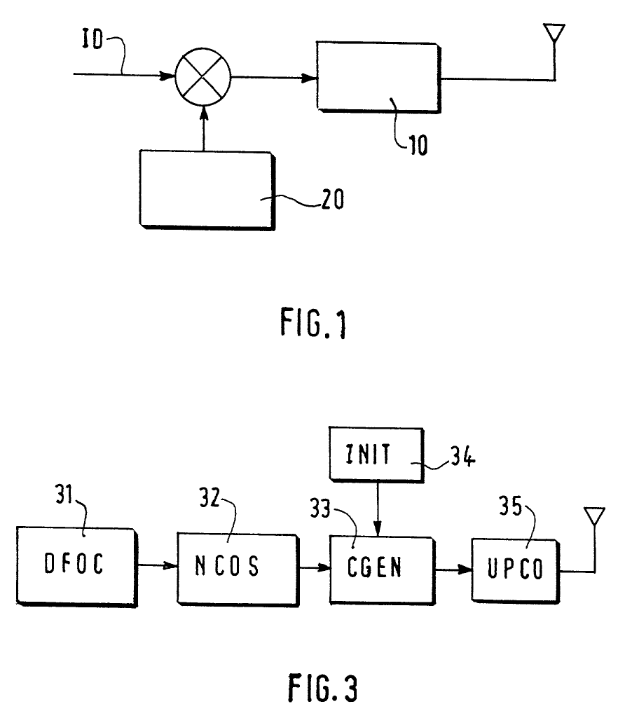

In a conventional CDMA transmitter, such as shown in FIG. 1, the input data ID to be transmitted modulate, before up-conversion in an up-converter 10 and transmission, at least one pseudo-noise code period (defined by means of a pseudo-noise code generator 20) whose frequency is much higher than that of data. In the proposed CDMA transmitter, the principle according to the invention is different. The data information is contained in a frequency offset. This means that the data drive a frequency synthesizer which, in turn, generates the clock of the pseudo-noise code generator with a slight frequency offset, without any effect on the bandwidth. It may be highlighted that this technique is different from the well-known frequency hopping technique. In a typical frequency-hopping transmitter, a pseudo-random hopping code is used to control the output frequency of a phase-locked loop-based synthesizer, and, in the receiver, an identical copy of the hopping patterns is used to recover the FM carrier modulated with the data.

During the reception and after acquisition process (i.e., after the synchronization of the received signal with the local pseudo-noise code within one chip), for each code period, a frequency offset detector stores each frequency offset, corrected by a tracking loop. Said detection is based on a correlation operation allowing to distinguish the frequency offsets. For instance, two different frequency offsets correspond to two distinct peak amplitudes detected by a correlator stage of the receiver. Thus, the data demodulation can be done easily.

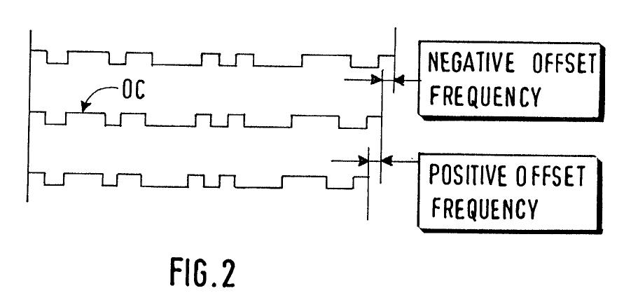

The principle of the code sliding is illustrated in FIG. 2. The middle line shows an example of original code OC, while the upper and lower lines show the same code but on which a frequency offset can be observed (the upper line corresponds to a code sliding due to a negative offset frequency and the lower one to a code sliding due to a positive offset frequency). This principle may be carried out for instance by a transmitter shown in FIG. 3. In a modulation stage of said transmitter, a data-to-frequency offset converter 31 (DFOC) controls a frequency synthesizer, such as an oscillator 32, e.g., a numerically controlled oscillator (NCOS), the clock output of which is received by a code generator 33 (CGEN). According to the invention, the code generator 33 is initialized by an initialization module 34 (INIT) each period of the transmitted pseudo-noise code (i.e., each data symbol). The output of the modulation stage is received by an up- converter 35 (UPCO) which translates the output to a frequency suitable for transmission.

The subject invention may be used with multi-code data, i.e., data which can have any of, for example, four different values, e.g., +1, +2, −1 and −2. The transmitter of the subject invention would then perform a two-level modulation. To that end, the data-to-frequency converter 31 selects one of a plurality of predefined offset values corresponding to the value of the particular data item. Table 1 shows an example of the offset values (OF) for the corresponding data-item value (DATA):

TABLE 1

| OF | DATA |
|---|---|
| +fₘ | +1 |
| +2fₘ | +2 |
| −fₘ | −1 |
| −2fₘ | −2 |

The code-to-frequency converter 31 then applies the selected offset value to the oscillator 32 which then generates the clock with the selected offset value for the code generator 33.

Reciprocally, a receiver is provided for implementing a subsequent down-conversion and demodulation process. In the receiver, such as illustrated in FIG. 4, the base-band signal is received by a demodulation branch 41, a calibration branch 42 being connected to the demodulation branch 41 during a so-called calibration step. In the described implementation, and in the case of a mapping principle (carried out at the transmitting side) for a two-level modulation, a frequency offset of a value fₘ (such that the code shift however does not exceed one chip during the correlation period of the receiver) has been added to the nominal pseudo-noise code frequency.

In the receiver of FIG. 4, the calibration branch 42, comprising, in series, a switch 421, a filter 422 (F), an oscillator 423 and a code generator 424 (CG) controlling a shift register 425 (SR) connected to the correlation part of the demodulation branch 41, is provided in order to solve the case of an unknown frequency offset induced, for example, by Doppler effect (due to the motion of the transmitter or the receiver). The switch 421 is in “open” position, except during the calibration step. If the transmitter periodically sends (each P code period(s), with P>1) one code period without any frequency offset, the calibration branch allows the receiver to detect the correct data in spite of such unknown offsets. The demodulation branch 41 comprises first and second correlators 411 and 412 receiving the input baseband received signal. These correlators are controlled by the shift register 425 and apply their output signals to a comparison circuit (413, 414, 415), at the output of which a decision circuit 416 yields the demodulated data DEMD. The comparison circuit includes an inverter 413 connected to the output of the first correlator 411, an adder 414 for adding the inverted output from the first correlator 411 and the output from the second correlator 412, and a comparator 415 for comparing the output from the adder 414 to a plurality of predetermined thresholds.

Table 2 given hereunder is an example of the relation between the frequency offsets and the data for the two-level modulation here described:

TABLE 2

| OF | 1COA | 2COA | DATA |
|---|---|---|---|
| +fₘ | α | ε | +1 |
| +2fₘ | 2α | 2ε | +2 |
| −fₘ | ε | α | −1 |
| −2fₘ | 2ε | 2α | −2 |

in which OF designates the offset frequency, 1COA designates the first correlator output amplitude at the end of the correlation period, 2COA designates the second correlator output amplitude at the end of the correlation period, and ε<<α.

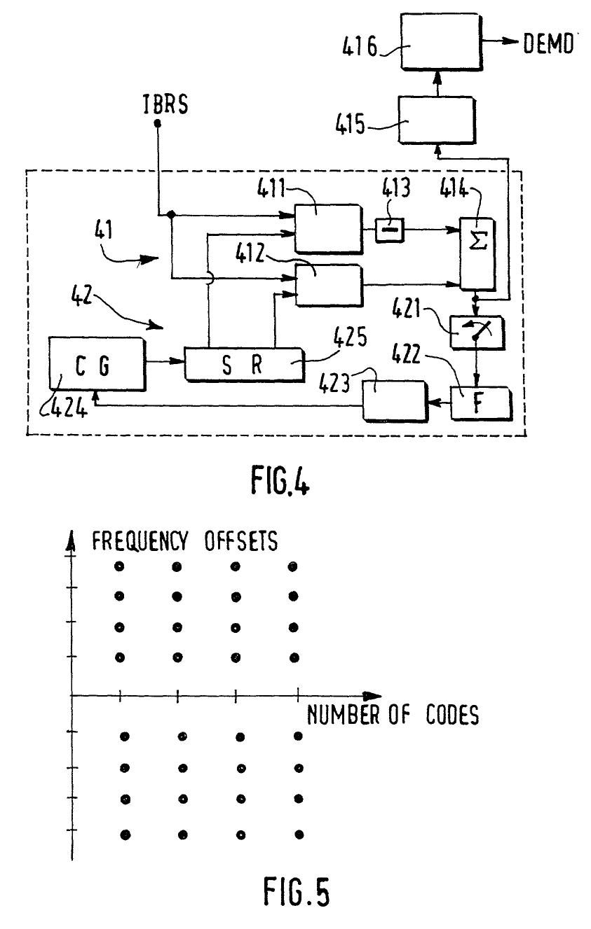

The invention is by no means limited to the above-described implementation. It is clear, for instance, that, in the modulation stage of the transmitter, multi-code with different frequency offsets may also be used, as illustrated, for instance, 20 in FIG. 5.

When a frequency offset of fₘ or 2fₘ (or −fₘ or −2fₘ) has been added to the nominal pseudo-noise code frequency, the output amplitude of the first correlator 411 rises to a value α, for fₘ, and to a value 2α, for 2fₘ. However, when subtracting fₘ or 2fₘ, the second correlator 412 sees its output amplitude rise to a value of a (for −fₘ) or 2α (for −2fₘ), which finally leads to the demodulated data indicated in the last column of Table 2 (at the end of each correlation period, the difference between the late and the early correlation results, computed by means of the inverter 413 and the adder 414, is compared in the comparator 415 to predetermined thresholds the number of which depends on the number of data). According to the result of the decision then taken in the decision circuit 416, a double information may be extracted, as illustrated in Table 2, i.e., the sign of the difference and the amplitude, according to the levels of the thresholds (which, in turn, depend on the levels of the modulation that has been used).

It is therefore seen that a main feature of the invention is the possibility to transport more than one data bit information over a single period of the pseudo-noise code, which is not possible with the conventional direct sequence spread spectrum modulation (or DS-CDMA modulation) technique. This advantage can be obtained if enough signal-to-noise ratio is available. Moreover, under the same conditions, the acquisition process according to the invention is faster, compared to the DS-CDMA modulation technique, due to the presence, in the known technique, of data amplitude modulation, which leads to situations where the code synchronizing processor continues the search for the code synchronization, even though synchronization has already been achieved. Such situations increase the probability of missing detection and lead to a longer acquisition time, with respect to the case of the invention that does not suffer from that problem since no data amplitude modulation is applied.

Numerous alterations and modifications of the structure herein disclosed will present themselves to those skilled in the art. However, it is to be understood that the above described embodiment is for purposes of illustration only and not to be construed as a limitation of the invention. All such modifications which do not depart from the spirit of the invention are intended to be included within the scope of the appended claims.

What is claimed is:

1. A code division multiple access transmitter comprising:
a modulation stage; and
an up-converter coupled to an output of said modulation stage,
characterized in that the modulation stage comprises:
a data-to-frequency offset converter for receiving a data-item that is one of a plurality of states, said data-to-frequency converter providing, as an output, a select offset of a plurality of predefined offsets based on the input data-item;
a frequency synthesizer controlled by the converter, said frequency synthesizer generating a clock with a frequency offset that corresponds to the select offset of the plurality of predefined offsets; and
a code generator coupled to receive the clock from the frequency synthesizer.

2. The code division multiple access transmitter as claimed in claim 1, wherein multi-code with different frequency offsets is used in the modulation stage.

3. The code division multiple access transmitter as claimed in claim 1, wherein the plurality of states corresponds to a quadrature encoding of {+1, −1, +2, and −2}.

4. A code division multiple access transmitter according to claim 1, wherein the plurality of predefined offsets correspond to frequency offsets of {+fₘ, −fₘ, +2fₘ, and −2fₘ}.

5. A code division multiple access receiver for receiving a modulated signal having frequency offsets corresponding to the modulating data, said code division multiple access receiver comprising:
a down-converter for down-converting a received modulated signal to a baseband modulated signal; and
a demodulation stage coupled to an output of the down- converter,
characterized in that the demodulation stage comprises:
one or more correlators for detecting the frequency offsets in the modulated signal; and
a decoder for providing corresponding demodulated data based on the frequency offsets.

6. The code division multiple access receiver as claimed in claim 5, characterized in that the code division multiple access receiver further comprises:
a calibration stage coupled to the demodulation stage, said calibration stage comprising:
a reference code generator coupled to the one or more correlators;
a switch for selectively coupling the calibration stage to an output of the demodulation stage; and
oscillator means coupled to said switch, an output of said oscillator means being coupled to a control input of said reference code generator,
whereby said calibration stage provides a periodic frequency control of the reference code generator before data demodulation.

7. The code division multiple access receiver as claimed in claim 5, characterized in that, for frequency offset values of fₘ and 2fₘ in the modulated signal, demodulated data are obtained according to the corresponding phase and amplitude of output signals of the one or more correlators.
